(19) United States
(12) Patent Application Publication
(10) Pub. No.: US 2015/0220170 A1
(43) Pub. Date: Aug. 6, 2015

(54) TOUCH-SENSING APPARATUS AND METHOD

(71) Applicant: MELFAS, INC., Seongnam-si, Gyeonggi-do (KR)

(72) Inventors: Sung Sik Nam, Seoul (KR); Seob Kim, Seoul (KR)

(73) Assignee: Melfas, INC., Seongnam-si, Gyeonggi-do (KR)

(21) Appl. No.: 14/420,650

(22) PCT Filed: Aug. 9, 2013
(86) PCT No.: PCT/KR2013/007182

§ 371 Date: Feb. 9, 2015

(30) Foreign Application Priority Data
Aug. 9, 2012 (KR) 10-2012-0087282

(51) Int. Cl. G06F 3/041

(52) U.S. Cl. CPC G06F 3/041

(57) ABSTRACT

Provided is a touch-sensing apparatus. The touch-sensing apparatus comprises: a touch panel for taking, as an input, a touch signal; and a control unit including a noise calculation part for calculating the level of the noise inputted via the touch panel, and an operation mode determining part for determining an operation mode of the touch panel to be either a general mode or a noise mode based on whether or not a touch input has occurred and based on the noise level.

### TECHNICAL FIELD

Embodiments of the inventive concept relate to touch sensing device and method, and in particular, to touch sensing device and method capable of coping with generation of noise flexibly.

### BACKGROUND ART

A touch sensing device includes a touch panel and recognizes a user's screen touch or gesture from the touch panel as input information. The touch panel of the touch sensing device is classified as a resistive type, a capacitive type, an ultrasonic wave type, or an infrared type according to an operating manner. Among such types, the capacitive type receives attention in that a multi-touch input is easy.

In a capacitive-type touch sensing device, two sorts of noise may occur. One is environmental noise that is generated due to peripheral environment of the touch sensing device, and the other is user noise that is generated due to a user's touch input. The environmental noise means noise due to EMI (ElectroMagnetic Interference) that is generated from any other electronic device of the touch sensing device. For example, the touch panel of the touch sensing device is generally disposed on a display panel for displaying images. For this reason, the touch panel is interfered with driving signals for driving a display panel (e.g., an LCD panel) and with any other electronic device(s) in the vicinity of the touch panel. The user noise means noise that is generated when the touch panel is touched by a user. For example, the user noise may be generated by a charger and may be generated only if the touch panel is touched by the user.

In the event that noise is generated from the touch panel due to the environmental noise and/or the user noise, touch accuracy of the touch panel is lowered. Accordingly, there is required a touch sensing device capable of coping with a variety of noise flexibly.

### DISCLOSURE

### Technical Problem

Embodiments of the inventive concept provide touch sensing device and method capable of coping with abnormality of function due to a variety of noise.

Embodiments of the inventive concept provide touch sensing device and method capable of operating in an operating mode appropriately according to a condition where noise is generated.

Embodiments of the inventive concept provide touch sensing device and method capable of appropriately switching an operating mode according to a condition where noise is generated.

### Technical Solution

A touch sensing device according to an exemplary embodiment of the inventive concept includes a touch panel configured to receive a touch input; and a control unit including a touch determining part configured to determine whether a touch input is generated on the touch panel, based on the touch signal; a noise calculation part configured to calculate a level of noise input on the touch panel; and an operation mode determining part configured to select one of a noise mode and a normal mode as an operating mode of the touch panel, based on the calculated noise level.

A touch sensing device according to another exemplary embodiment of the inventive concept includes a touch panel configured to receive a touch input; and a control unit including a touch determining part configured to determine whether a touch input is generated on the touch panel and a duration of the touch input; a noise determining part configured to determine whether noise is generated on the touch panel; and an operation mode determining part configured to switch an operating mode of the touch panel from a normal mode to a noise mode, based on whether noise is generated, whether the touch input is generated, and whether the touch panel operates abnormally.

A touch sensing method according to still another exemplary embodiment of the inventive concept includes determining whether a touch input is generated on a touch panel for receiving a touch signal; calculating a level of noise input on the touch panel; and selecting one of a noise mode and a normal mode as an operating mode of the touch panel, based on whether the touch input is generated and the calculated noise level.

A touch sensing method according to a further exemplary embodiment of the inventive concept includes determining whether a touch input is generated on a touch panel for receiving a touch signal and a duration of the touch input; determining whether noise is generated on the touch panel; determining whether the touch panel operates abnormally; and switching an operating mode of the touch panel from a normal mode to a noise mode, based on whether the touch input is generated, whether noise is generated, and whether the touch panel operates abnormally.

Other specific items of the embodiments are included in the detailed description and figures.

### Advantageous Effects

Embodiments of the inventive concept have at least the following effects.

That is, it is possible to provide touch sensing device and method capable of coping with abnormality of function due to a variety of noise.

Also, it is possible to provide touch sensing device and method capable of operating in an operating mode appropriately according to a condition where noise is generated.

Further, it is possible to provide touch sensing device and method capable of appropriately switching an operating mode according to a condition where noise is generated.

The effects according to the inventive concept may not be limited by the contents disclosed in this specification, and various effects may be included in this specification.

### DESCRIPTION OF DRAWINGS

FIGS. 1 and 2 are block diagrams schematically illustrating a touch sensing device according to an exemplary embodiment of the inventive concept;

FIG. 3 is a flowchart for describing a touch sensing method according to an exemplary embodiment of the inventive concept;

FIGS. 4 to 10 are graphs for describing an operation of a touch sensing device according to an exemplary embodiment of the inventive concept;

FIG. 11 is a flowchart for describing a touch sensing method according to another exemplary embodiment of the inventive concept;

FIG. 12 is a graph showing a touch signal by the lapse of time when a driving signal is applied to the touch panel 10;

FIGS. 13 and 14 are block diagrams schematically illustrating a touch sensing device according to another exemplary embodiment of the inventive concept;

FIG. 15 is a flowchart of a touch sensing method according to another exemplary embodiment of the inventive concept; and

FIG. 16 is a graph for describing an operation of a touch sensing device according to another exemplary embodiment of the inventive concept.

### BEST MODE

Hereinafter, exemplary embodiments of the present invention will be described. In the drawings, the thickness and spacing are schematically illustrated for convenience in description and may be exaggerated in comparison to an actual thickness. In describing the present invention, a well-known configuration unrelated to the gist of the present invention may be omitted.

It will also be understood that when a layer is referred to as being “between” two layers, it can be the only layer between the two layers, or one or more intervening layers may also be present. Unless otherwise noted, like reference numerals denote like elements throughout the attached drawings and written description, and thus descriptions will not be repeated.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Below, embodiments of the inventive concept will be more fully described with reference to accompanying drawings.

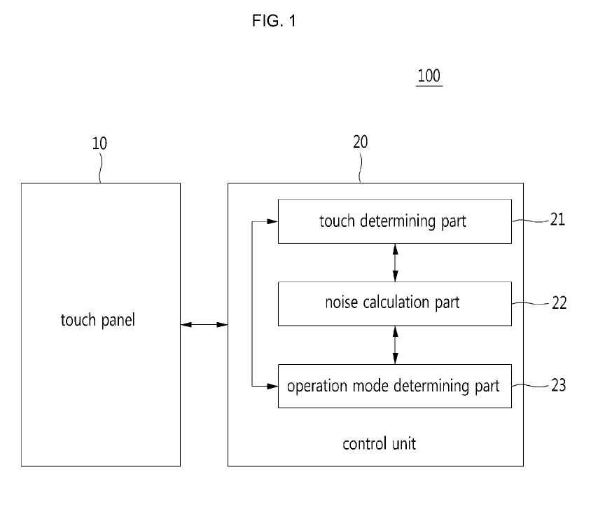

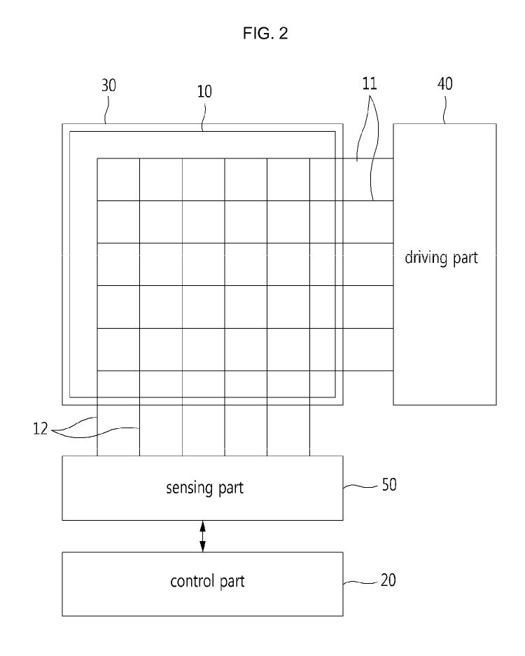

FIGS. 1 and 2 are block diagrams schematically illustrating a touch sensing device according to an exemplary embodiment of the inventive concept. Referring to FIG. 1, a touch sensing device 100 contains a touch panel 10 and a control unit 20 including a touch determining part 21, a noise calculation part 22, and an operation mode determining part 23. Referring to FIG. 2, the touch sensing device 100 further includes a display panel 30, a driving part 40, and a sensing part 50. The touch panel 10 includes a plurality of driving electrodes 11 and a plurality of sensing electrodes 12.

The touch panel 10 is disposed on the display panel 30 for displaying images and receives a user's touch input. The touch panel 10 is a panel for receiving user's touch inputs and is implemented to have various forms. However, the touch panel 10 may not be limited to a specific form. For example, the touch panel 10 may be formed of two layers. In this case, a touch sensor may be implemented with an array of pixels that are arranged at intersections of a plurality of sense electrode traces (e.g., traces extending in an X-axis direction) and a plurality of driving electrode traces (e.g., traces extending in a Y-axis direction). Alternatively, the touch panel 10 may be implemented with a touch panel that has single-layered touch sensors disposed on the same plane and fabricated on one surface of a single substrate. The driving and sense electrode traces may be fabricated to have bar shapes of a first axis direction and as divided electrodes of a second axis direction. Each bar shape of the first axis direction may be connected with an individual metal interconnection in a boundary area of the touch panel 10, and electrodes, formed on the same first axis, from among the divided electrodes of the second axis direction may be connected together using individual metal interconnections in the boundary area of the touch panel 10.

The touch panel 10 includes a plurality of driving electrodes 11 for applying a driving signal to the touch panel 10 and a plurality of sense electrodes 12 for transferring a user's touch signal input on the touch panel 10. In FIG. 2, an embodiment of the inventive concept is exemplified as the touch panel 10 includes the driving electrodes 11 and the sense electrodes 12. However, the scope and spirit of the inventive concept may not be limited thereto. For example, the touch panel 10 may include various electrode traces and various interconnections as described above.

The driving part 40 applies a driving signal to the touch panel 10 through the plurality of driving electrodes 11, and the sensing part 50 receives a touch signal from the touch panel 10 through the plurality of sense electrodes 12. The sensing part 50 transfers the input touch signal to the control unit 20. Signal exchange between the sensing part 50 and the control unit 20 will be more fully described later.

The driving part 40 sequentially applies a driving signal to the driving electrodes 11. For example, the driving part 40 drives the driving electrodes 11 shown in FIG. 2 such that a driving signal is first applied to the uppermost driving electrode of the driving electrodes 11 and is finally applied to the lowermost driving electrode thereof. A time period when a driving signal is applied to each driving electrode 11 remains constant. After applied to the lowermost driving electrode 11, the driving signal is again applied to the uppermost driving electrode 11. In FIG. 2, there are illustrated a total of six driving electrodes 11. However, the scope and spirit of the inventive concept may not be limited thereto. The number of driving electrodes 11 may be variously changed.

In addition, the driving part 40 does not provide all of the driving electrodes 11 with the driving signal during a specific time period. For example, after sequentially applying the driving signal from the uppermost driving electrode 11 of the driving electrodes shown in FIG. 2 to the lowermost driving electrode 11 thereof, the driving part 40 does not provide all of the driving electrodes 11 with the driving signal during the same time period as a time period when each driving signal is applied to the driving electrode 11. The driving signal is again applied from the uppermost driving electrode 11 after the time period when no driving signal is applied passes

In this specification, it is assumed that after sequentially applying the driving signal from the uppermost driving electrode 11 to the lowermost driving electrode 11, the driving part 40 does not provide all of the driving electrodes 11 with the driving signal during the same time period as a time period when each driving signal is applied to the driving electrode 11 and again applies the driving signal from the uppermost driving electrode 11 after the time period when no driving signal is applied passes. However, the scope and spirit of the inventive concept may not be limited thereto. For example, the driving part 40 may apply the driving signal in various manners or may not apply it in various manners. Also, a sum of a time period when the driving part 40 sequentially applies the driving signal from the uppermost driving electrode 11 to the lowermost driving electrode 11 and a time period when the driving signal is not applied to all the driving electrodes 11 may be defined as a frame.

The sense electrodes 12 may always sense a touch signal regardless of whether a driving signal is applied from the driving part 40. That is, the sense electrodes 12 may sense the touch signal during a time period when the driving signal is not applied to each driving electrode 11 as well as during a time period when the driving signal is applied to each driving electrode 11.

The touch sensing device 100 further includes the display panel 30. The display panel 30 is a panel for displaying images. The display panel 30 may be a Liquid Crystal Display (LCD) panel, an electrophoretic display panel, an inorganic Electro Luminescent (EL) display panel, an Organic Light Emitting Diode (OLED) panel, an LED panel, a Field Emission Display (FED) panel, a Surface-conduction Electron-emitter Display (SED) panel, a Plasma Display Panel (PDP), or a Cathode Ray Tube (CRT) display panel. The touch panel 10 may be stacked on one surface of the display panel 30. For the sake of easy understanding, an embodiment of the inventive concept is exemplified in FIG. 2 as the size of the display panel 30 is larger than that of the touch panel 10. However, the scope and spirit of the inventive concept may not be limited thereto. For example, the sizes of the display panel 30 and the touch panel 10 may be decided independently of each other.

The control unit 20 is provided with the sensing signal from the touch panel 10 and controls an operation of the touch panel 10. The control unit 20 includes the following to control an operation of the touch panel 10: the touch determining part 20, the noise calculation part 22, and the operation mode determining part 23. In this specification, an embodiment of the inventive concept is exemplified as the control unit 20 is formed of discrete components, that is, the touch determining part 20, the noise calculation part 22, and the operation mode determining part 23. However, the scope and spirit of the inventive concept may not be limited thereto. For example, the touch determining part 20, the noise calculation part 22, and the operation mode determining part 23 may be integrated in one component or may be divided into more various components.

The operation mode determining part 23 determines or switches an operating mode of the touch panel, based on a level of noise generated from the touch panel 10. The operation mode determining part 23 may select one of a normal mode and a noise mode as the operating mode of the touch panel 10. The operating mode of the touch panel 10 may be switched from the normal mode to the noise mode or from the noise mode to the normal mode. In the touch sensing device 100 according to an exemplary embodiment of the inventive concept, the operation mode determining part 23 additionally determines whether a touch input occurs on the touch panel 10 and sets the operating mode of the touch panel 10 to the noise mode according to the determination result.

As the operating mode of the touch panel 10, the normal mode may mean a mode where the touch panel 10 operates substantially the same as firstly designed without specific restriction about the touch panel 10. As the operating mode of the touch panel 10, the noise mode may mean a mode where the usability of the touch panel 10 is reduced as compared with the normal mode. If the touch panel 10 is normally driven when a value of noise generated from the touch panel 10 is over a specific threshold value, accuracy of calculating a touch position is reduced due to the noise, and a lot of time is consumed to calculate the touch position. Thus, when a value of noise generated from the touch panel 10 is over the specific threshold value, the operating mode of the touch panel 10 is switched into the noise mode, thereby preventing an abnormal operation of the touch panel 10. In this specification, the term “usability” of the touch panel 10 may mean specific performance of the touch panel 10. For example, the “usability” of the touch panel 10 may mean sensitivity of the touch panel 10, a touch signal sensing speed, or a multi-touch determination ability of the touch panel 10 or a combination thereof.

The operation mode determining part 23 may determine one of the normal mode and the noise mode as an initial (or first) operating mode of the touch panel 10. However, the normal mode may be selected as the initial (or first) operating mode of the touch panel 10. That is, since the normal mode may be an operating mode that is executed under the assumption that noise enough to affect an operation of the touch panel 10 does not exist, the touch panel 10 may operate in the normal mode under the assumption. Afterwards, the normal mode may be switched into the noise mode by the operation mode determining part 23. In this specification, it is assumed that an initial (or first) operating mode of the touch panel is the normal mode.

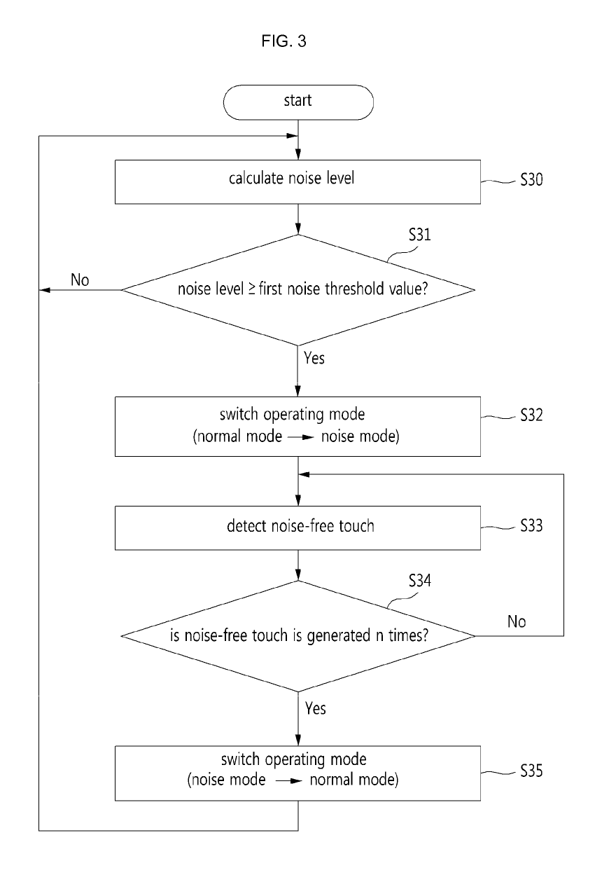

Below, a detailed operation of the operation mode determining part 23 will be more fully described with reference to FIG. 3. FIG. 3 is a flowchart for describing a touch sensing method according to an exemplary embodiment of the inventive concept.

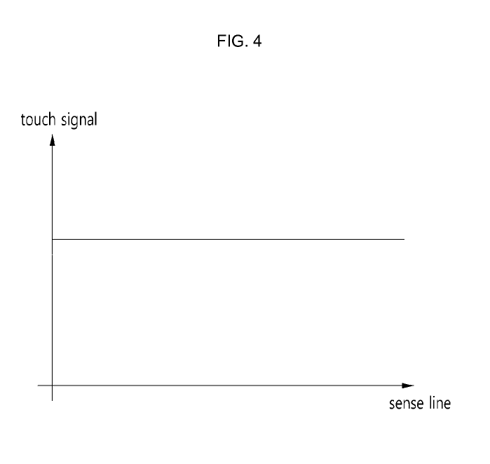

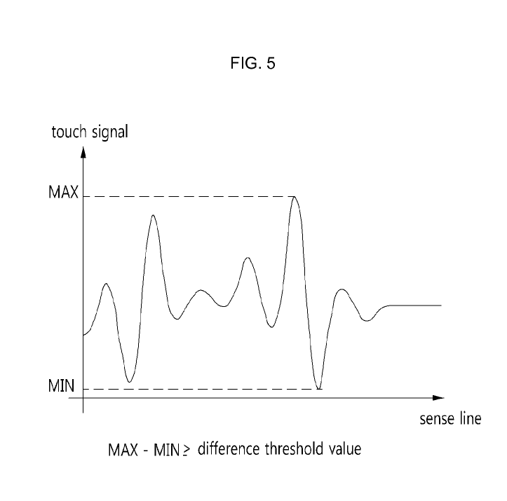

First, in step S30, a noise calculation part 22 calculates a level of noise input through a touch panel 10. An operation in which the noise calculation part 22 calculates a noise level will be more fully described with reference to FIGS. 4 and 5.

FIGS. 4 and 5 are graphs for describing an operation of a touch sensing device according to an exemplary embodiment of the inventive concept. FIGS. 4 and 5 show a touch signal of a sense electrode 12 when a driving signal is not applied to a touch panel 10. In FIGS. 4 and 5, the abscissa means a sense electrode 12, and the ordinate means a level of a touch signal sensed from each sense electrode 12.

A noise calculation part 22 detects touch signals from a plurality of sense electrodes 12 when a driving signal is not applied to driving electrodes 11 and calculates a noise level based on a sum of the detected touch signals. Here, the noise level may be defined as a sum of touch signals (noise signals) from the sense electrodes 12 during a time period when no driving signal is applied. Also, when a driving signal is not applied to driving electrodes 11, the noise calculation part 22 detects a maximum value and a minimum value of values of touch signals detected from the plurality of sense electrodes 12. The noise calculation part 22 calculates the noise level based on a difference between the maximum value and the minimum value.

In the event that no driving signal is applied to the driving electrodes of the touch panel 10 and no noise occurs, any touch signal is not detected from the sense electrodes 12. This means that no problem arises.

If environment noise exists on the touch panel 10, that is, when noise is generated due to any peripheral electronic device, a touch signal according to the environment noise may be sensed from the sense electrodes 12 even though no driving signal is applied. Also, since the environment noise affects the whole of the touch panel 10, as illustrated in FIG. 4, relatively uniform noise may be measured from the sense electrodes 12.

Also, user noise may exist when a user's touch input is provided on the touch panel 10. A touch signal according to the user noise may be sensed from the sense electrodes 12 even though no driving signal is applied. Further, since generated according to the touch input, the user noise may not affect the whole of the touch panel 10 uniformly. Accordingly, as illustrated in FIG. 5, noise of which the variation is great may be measured from the sense electrodes 12. Though not shown, a touch signal detected when both the environment noise and the user noise exist may correspond to a sum of graphs shown in FIGS. 4 and 5.

Referring to FIGS. 4 and 5, when the environmental noise exists, that is, when a user's touch input does not exist, a value of a touch signal measured from each sense electrode 12 may be uniform. This means that a difference between a maximum value and a minimum value of values of the touch signals is very small. However, if the user noise exists, that is, when a user's touch input exists, a value of a touch signal measured from each sense electrode 12 is considerably varied. Thus, in the event that no driving signal is applied to driving electrodes 11, that a sum of values of touch signals detected from the sense electrodes 12 is over a threshold value means that noise is generated due to a user's touch input.

Meanwhile, in the event that no driving signal is applied to driving electrodes 11, that a difference between a maximum value and a minimum value of values of touch signals is over a difference threshold value means that noise is generated due to a user's touch input. Here, the difference threshold value may mean a difference between a maximum value and a minimum value of touch signal values that is used as a reference for determining whether the user noise according to a touch input is generated.

When no driving signal is applied to the driving electrodes 11, the noise calculation part 22 detects touch signals from the sense electrodes 12 to sum the detected touch signals, or detects a maximum value and a minimum value of values of the detected touch signals and calculates a noise level based on a difference between the maximum value and the minimum value. In detail, that a sum of values of touch signals is below a specific threshold value when no driving signal is applied may mean that noise due to a user's touch input does not exist. In this case, the noise calculation part 22 does not calculate the noise level. That a sum of values of touch signals is over the specific threshold value when no driving signal is applied may mean that noise due to a user's touch input exists. In this case, the noise calculation part 22 calculates the noise level.

In other exemplary embodiments, that a difference between the maximum value and the minimum value is over the difference threshold value when no driving signal is applied may mean that noise due to a user's touch input exists. In this case, the noise calculation part 22 calculates the noise level. In still other exemplary embodiments, the noise calculation part 22 calculates the noise level regardless of whether a difference between the maximum value and the minimum value is greater than or smaller than the difference threshold value.

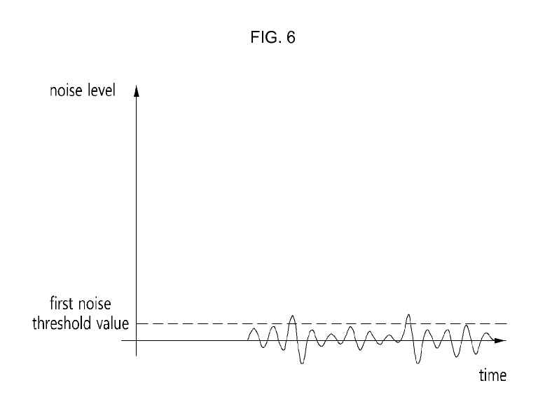

Returning to FIG. 3, in step S310, the operation mode determining part 23 determines whether the noise level is over a first noise threshold value. An operation of the operation mode determining part 23 will be more fully described with reference to FIG. 6.

FIG. 6 is a graph for describing an operation of a touch sensing device according to an exemplary embodiment of the inventive concept. FIG. 6 is a graph showing a noise level by the lapse of time.

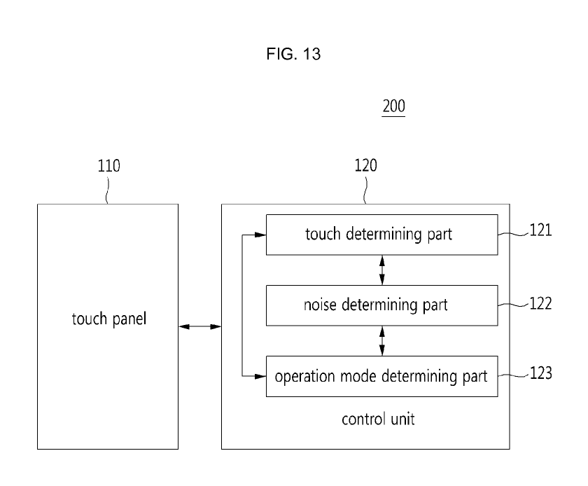

When no driving signal is applied to the driving electrodes 11, an operation mode determining part 23 decides a value, corresponding to a sum of values of touch signals acquired from the sense electrodes 12, as a noise level. If the noise level is over a first noise threshold value, in step S32, the operation mode determining part 23 switches the operating mode of the touch panel 10 from the normal mode to the noise mode. The first noise threshold value means a minimum noise level at which the operating mode of the touch panel 10 is switched from the normal mode to the noise mode. Referring to FIG. 6, the operation mode determining part 23 switches the operating mode of the touch panel 10 from the normal mode to the noise mode at a first point in time when the noise level is over the first noise threshold value. The point in time when the operating mode of the touch panel 10 is switched from the normal mode to the noise mode by the operation mode determining part 23 will be more fully described with reference to FIGS. 13 to 17.

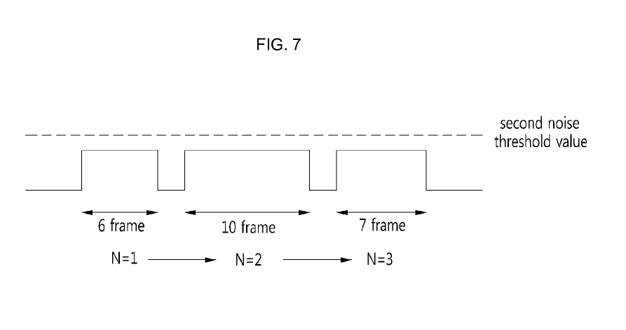

Returning to FIG. 3, in step S32, the operation mode determining part 23 detects a noise-free touch. In step S34, the operation mode determining part 23 determines whether the noise-free touch is generated n times. In step S35, the operation mode determining part 23 switches the operating mode of the touch panel 10 from the noise mode to the normal mode based on the determination result. An operation of the operation mode determining part 23 will be more fully described with reference to FIGS. 7 to 10.

FIGS. 7 to 10 are graphs for describing an operation of a touch sensing device according to an exemplary embodiment of the inventive concept.

An operation mode determining part 23 switches an operating mode of a touch panel 10 from a noise mode to a normal mode based on a noise level. In some embodiments, when a noise-free touch is generated n times, the operation mode determining part 23 may switch the operating mode of the touch panel 10 from the noise mode to the normal mode.

The operation mode determining part 23 counts the number of events that the noise-free touch is generated and switches the operating mode of the touch panel 10 from the noise mode to the normal mode based on the number of events thus counted. In some embodiments, when the noise-free touch is generated three times, the operation mode determining part 23 switches the operating mode of the touch panel 10 from the noise mode to the normal mode. However, the number of events that the noise-free touch is generated is reset to “0” when there is generated a touch input having a noise level greater than a second noise threshold value.

The noise-free touch may be a user touch needed to switch the operating mode of the touch panel 10 from the noise mode to the normal mode and may mean the event that a touch input having a noise level smaller than the second noise threshold value is generated during a period longer than a first time period. The second noise threshold value may mean a maximum noise level where the operating mode of the touch panel 10 is switched from the noise mode to the normal mode. In some embodiments, the second noise threshold value may be identical to the first noise threshold value. The first time period may be a time period when a touch input is held such that it is recognized as a noise-free touch. In some embodiments, the first time period may be a time period corresponding to six frames. In detail, as described above, a time period corresponding to a sum of a time period when a driving part 40 sequentially applies a driving signal from the uppermost driving electrode 11 to the lowermost driving electrode 11 and a time period when the driving signal is not applied to all the driving electrodes 11 is a time period corresponding to one frame. For this reason, a time period corresponding to six frames may be a time period when there is six times performed a sequence where the driving part 40 sequentially applies a driving signal to each driving electrode and the driving signal is not applied to all the driving electrodes 11.

Referring to FIG. 7, three touches exist on the touch panel 10, and a first touch is held during a time period corresponding to six frames and has a noise level smaller than the second noise threshold value. In this case, an operation mode determining part 23 determines that a noise-free touch is generated once. Next, a second touch is held during a time period corresponding to ten frames and has a noise level smaller than the second noise threshold value. In this case, the operation mode determining part 23 determines that a noise-free touch is generated two times. Finally, a third touch is held during a time period corresponding to seven frames and has a noise level smaller than the second noise threshold value. In this case, the operation mode determining part 23 determines that a noise-free touch is generated three times. Thus, the operation mode determining part 23 may switch the operating mode of the touch panel 10 from the noise mode to the normal mode.

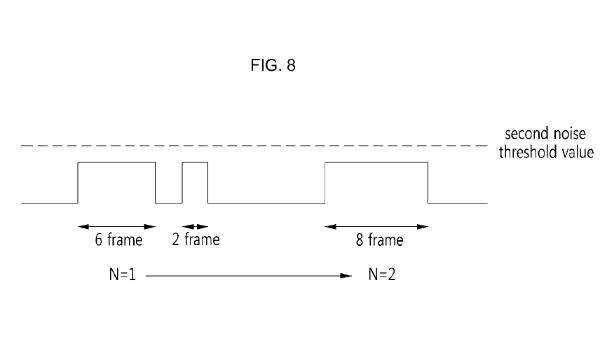

Referring to FIG. 8, three touches exist on the touch panel 10, and a first touch is held during a time period corresponding to six frames and has a noise level smaller than the second noise threshold value. In this case, the operation mode determining part 23 determines that a noise-free touch is generated once. Next, since a second touch has a noise level smaller than the second noise threshold value and its duration corresponds to two frames, the second touch is not recognized as a noise-free touch. However, since a noise level of the second touch is smaller than the second noise threshold value, the number of events that the noise-free touch is generated is not reset. Then, a third touch is held during a time period corresponding to eight frames and has a noise level smaller than the second noise threshold value. In this case, the operation mode determining part 23 determines that a noise-free touch is generated two times.

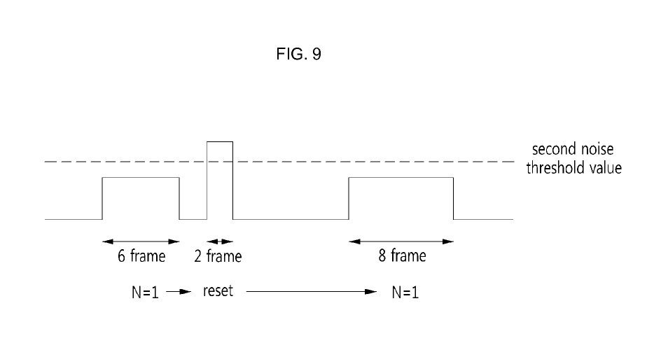

Referring to FIG. 9, three touches exist on the touch panel 10, and a first touch is held during a time period corresponding to six frames and has a noise level smaller than the second noise threshold value. In this case, the operation mode determining part 23 determines that a noise-free touch is generated once. Next, since a duration of a second touch corresponds to two frames, it does not satisfy a touch duration condition where the second touch is recognized as a noise-free touch. Also, since a noise level of the second touch is over the second noise threshold value, the number of events that the noise-free touch is generated is reset. Then, a third touch is held during a time period corresponding to eight frames and has a noise level smaller than the second noise threshold value. In this case, the operation mode determining part 23 determines that a noise-free touch is generated once.

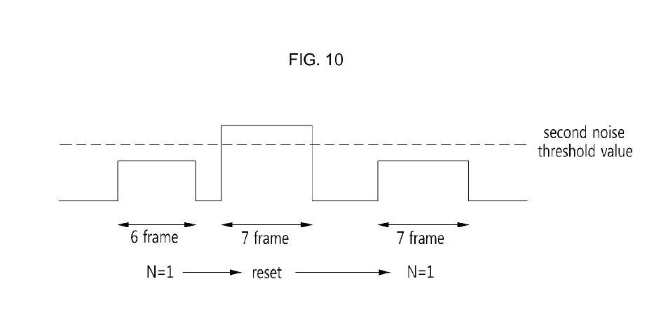

Referring to FIG. 10, three touches exist on the touch panel 10, and a first touch is held during a time period corresponding to six frames and has a noise level smaller than the second noise threshold value. In this case, the operation mode determining part 23 determines that a noise-free touch is generated once. Next, since a duration of a second touch is identical to a time period corresponding to seven frames, it satisfies the touch duration condition where the second touch is recognized as a noise-free touch. Only, since a noise level of the second touch is over the second noise threshold value, the number of events that the noise-free touch is generated is reset to “0”. Finally, a third touch is held during a time period corresponding to seven frames and has a noise level smaller than the second noise threshold value. In this case, the operation mode determining part 23 determines that a noise-free touch is generated once.

In touch sensing device and method according to an exemplary embodiment of the inventive concept, an operation mode of a touch panel may be switched from a normal mode to a noise mode or from the noise mode to the normal mode based on a condition where noise is generated, thereby making it possible to cope with abnormality of function due to various noise and to change the operating mode of the touch panel appropriately according to noise generated at the touch sensing device.

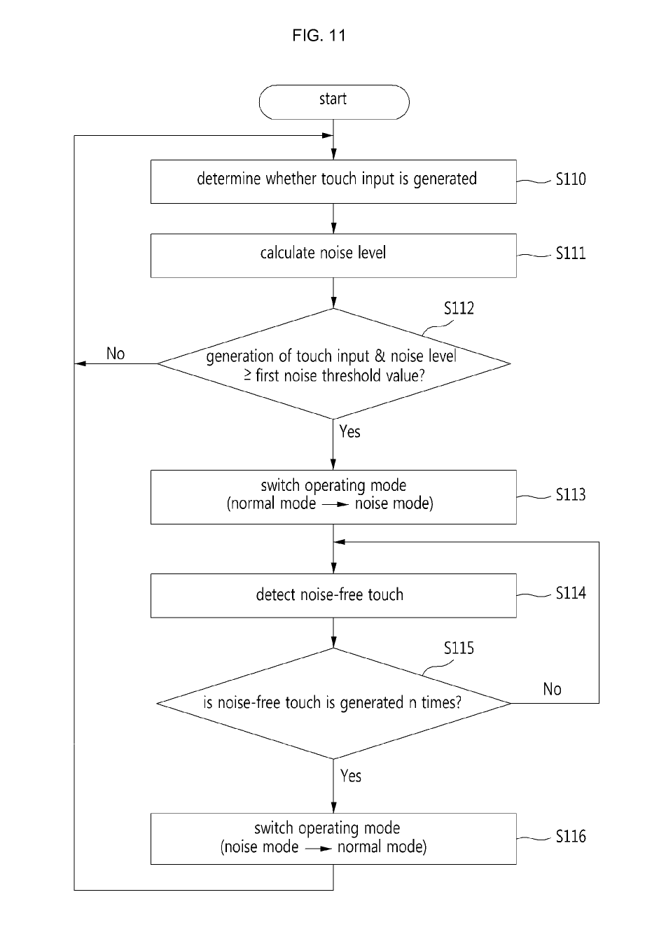

FIG. 11 is a flowchart for describing a touch sensing method according to another exemplary embodiment of the inventive concept.

First, in step S110, a touch determining part 21 determines whether a touch input is generated. An operation of the touch determining part 21 will be more fully described with reference to FIGS. 4, 5, and 12.

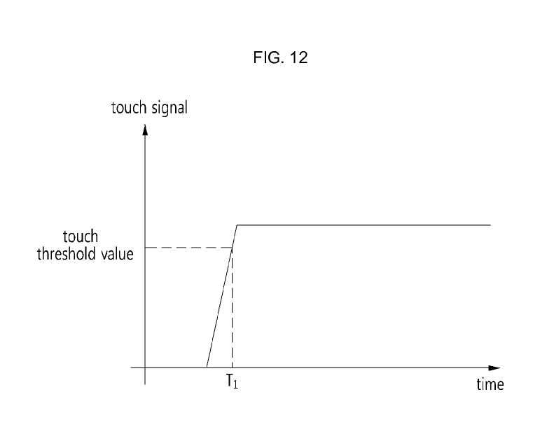

FIGS. 4, 5, and 12 are graphs for describing an operation of a touch sensing device according to various exemplary embodiments of the inventive concept. As described above, FIGS. 4 and 5 are graphs showing a touch signal of each sense electrode 12 when no driving signal is applied to a touch panel 10. In FIGS. 4 and 5, the abscissa means a sense electrode 12, and the ordinate means a level of a touch signal sensed from each sense electrode 12. FIG. 12 is a graph showing a touch signal by the lapse of time when a driving signal is applied to the touch panel 10. For the sake of easy understanding, an embodiment of the inventive concept is exemplified in FIG. 12 as a touch signal sensed from one of a plurality of sense electrodes 12 varies with the time.

Referring to FIG. 12, when a driving signal is sequentially applied to a plurality of driving lines 11, a touch determining part 21 determines whether a touch input is generated on the touch panel 10, based on levels of touch signals from a plurality of sense lines 12. In some embodiments, when a level of a touch signal is over a touch threshold value, the touch determining part 21 determines that a touch input is generated. The touch threshold value may mean a minimum touch signal value that is used as a reference for determining whether a touch input is generated. Referring to FIG. 4, when the touch panel 10 is touched by a user, a level of a touch signal input to the touch panel 10 gradually increases and exceeds the touch threshold value at time T1. In this case, the touch determining part 21 determines that a touch input is generated on the touch panel 10.

In step S111, a noise calculation part 22 calculates a noise level. An operation in which the noise calculation part 22 calculates a noise level may be substantially the same as that in which a noise calculation part of FIGS. 1 to 10 calculates a noise level, and a description thereof is thus omitted.

In step S112, an operation mode determining part 23 determines whether a touch input is generated and whether a noise level is over a first noise threshold value. When the noise level is over the first noise threshold value, in step S113, the operation mode determining part 23 switches an operating mode of a touch panel 10 from a normal mode to a noise mode. Determination associated with the noise level may be substantially the same as that described with reference to FIGS. 1 to 10 except that the noise level is over the first noise threshold value and the operation mode determining part 23 switches the operating mode when a touch input is generated, and a description thereof is thus omitted.

In step S114, the operation mode determining part 23 detects a noise-free touch. In step S114, the operation mode determining part 23 determines whether the noise-free touch is generated n times. In step S116, the operation mode determining part 23 switches the operating mode of the touch panel 10 from the noise mode to the normal mode. Steps S114 to S116 of FIG. 11 are substantially the same as steps S33 to S35 of FIG. 3, and a description thereof is thus omitted.

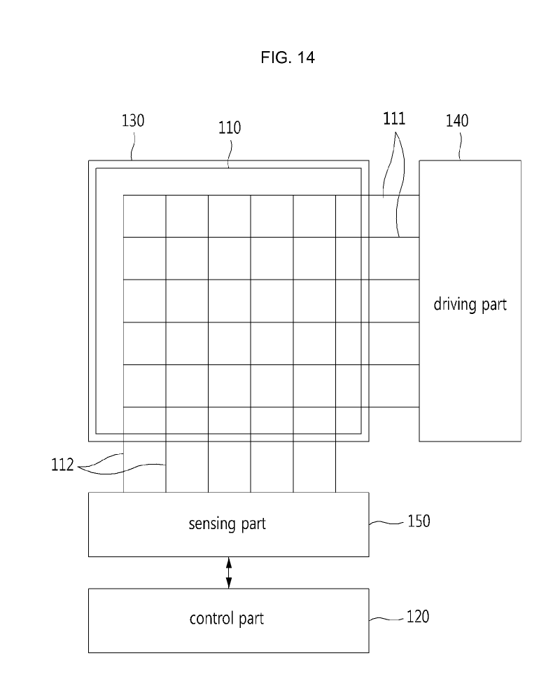

FIGS. 13 and 14 are block diagrams schematically illustrating a touch sensing device according to another exemplary embodiment of the inventive concept. Referring to FIG. 13, a touch sensing device 200 contains a touch panel 110 and a control unit 120 including a touch determining part 121, a noise determining part 122, and an operation mode determining part 123. Referring to FIG. 14, the touch sensing device 200 further includes a display panel 130, a driving part 140, and a sensing part 150. The touch panel 110 includes a plurality of driving electrodes 111 and a plurality of sensing electrodes 112. The components 110, 130, 140, and 150 of FIGS. 13 and 14 are substantially the same as those of FIGS. 1 to 12, and a duplicated description thereof is thus omitted.

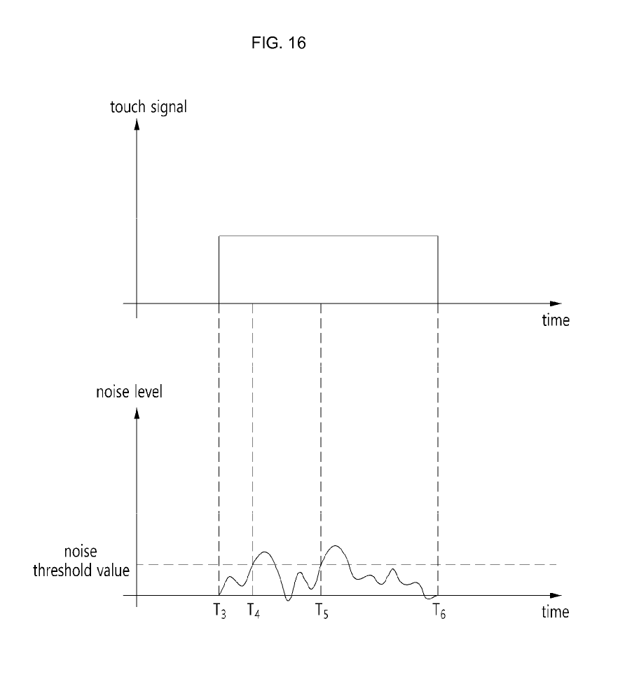

The control unit 120 contains a touch determining part 121 configured to determine whether a touch input is generated on the touch panel 110 and a duration of a touch input; a noise determining part 122 configured to determine whether noise is generated at the touch panel 110; and an operation mode determining part 123 configured to switch an operating mode of the touch panel 110 from a normal mode to a noise mode based on whether a touch input is generated, whether noise is generated, and whether the touch panel 110 operates abnormally. An operation of the control unit 120 will be more fully described with reference to FIG. 16.

FIG. 16 is a graph for describing an operation of a touch sensing device according to another exemplary embodiment of the inventive concept. Referring to FIG. 16, an upper graph is a graph showing a relationship between a time and touch signals sensed from all sense lines 112 during a time period, in which driving signals are applied to driving electrodes 111, from among continuous frame time periods. A lower graph is a graph showing a relationship between a time and levels of noise detected from all sense lines 112 ng a time period, in which driving signals are not applied to the driving electrodes 111, from among continuous frame time periods.

A touch determining part 121 is substantially the same as that described with reference to FIGS. 1 to 12 in that it determines whether a touch input is generated on a touch panel 110, and a duplicated description thereof is thus omitted. The touch determining part 121 also determines a duration of a touch input. Referring to FIG. 16, the touch determining part 121 determines the duration of the touch input to decide a touch input start time T3 and a touch input end time T6.

A noise determining part 122 calculates a noise level based on touch signals from the sense electrodes 112. When a noise level is over a noise threshold value, the noise determining part 122 determines that noise is generated on the touch panel 110. The noise threshold value means a minimum noise level at which an operating mode of the touch panel 110 is switched from a normal mode to a noise mode. Referring to FIG. 16, even though a touch input is generated at T3, the noise determining part 122 determines that no noise is generated, because a noise level is below the noise threshold value between T3 and T4. Since the noise level exceeds the noise threshold value at T4, the noise determining part 122 determines that noise is generated, at T4. Also, since the noise level exceeds the noise threshold value at T5, the noise determining part 122 determines that noise is generated, at T5.

An operation mode determining part 123 switches the operating mode of the touch panel 110 from the normal mode to the noise mode based on whether a touch input is generated, whether noise is generated, and whether the touch panel 110 operates abnormally. The operation mode determining part 123 receives information, indicating whether a touch input is generated, from the touch determining part 121. The operation mode determining part 123 receives information, indicating whether noise is generated, from the noise determining part 122. The operation mode determining part 123 switches the operating mode of the touch panel 110 from the normal mode to the noise mode based on whether the touch panel 110 operates abnormally. Also, the operation mode determining part 123 may determine a change point of the operating mode of the touch panel 110.

It is assumed that a touch input is generated on the touch panel 110 and the touch panel 110 operates abnormally at T4 when noise is generated. In this case, since the touch panel 110 operates abnormally due to the noise generated at T4, it is advantageous to make the touch panel 110 operate in the noise mode rather than the normal mode in which the usability of the touch panel 110 is higher than that in the noise mode. Accordingly, the operation mode determining part 123 switches the operating mode of the touch panel 110 from the normal mode to the noise mode immediately at T4.

Next, it is assumed that a touch input is generated on the touch panel 110 and the touch panel 110 operates normally at T4 when noise is generated. In this case, since the touch panel 110 does not operate abnormally though noise is generated at T4, it is advantageous to make the touch panel 110 operate in the normal mode rather than the noise mode in which the usability of the touch panel 110 is lower than that in the normal mode. Accordingly, the operation mode determining part 123 does not switch the operating mode of the touch panel 110 from the normal mode to the noise mode immediately at T4, but it switches the operating mode of the touch panel 110 from the normal mode to the noise mode after a duration of the touch input is ended, that is, at the touch input end time T6.

The following conditions are assumed. A touch input is generated on the touch panel 110 and the touch panel 110 operates normally at T4 when noise is generated. In contrast, a touch input is generated on the touch panel 110 and the touch panel 110 operates abnormally at T5 when noise is generated. According to the conditions, as described above, the operating mode is not switched at T4 and remains at the normal mode. Only, since the touch panel 110 operates abnormally at T5, the operation mode determining part 123 switches the operating mode of the touch panel 110 to the noise mode at T5.

It is assumed that a touch input is generated on the touch panel 110, the touch panel 110 operates normally at T4 when noise is generated, a touch input is generated on the touch panel 110, and the touch panel 110 operates normally at T5 when noise is generated. In this case, as described above, the operating mode of the touch panel 110 is not switched at T4 and remains at the normal mode. Also, since the touch panel 110 operates normally at T5, the operating mode of the touch panel 110 is not switched at T5 and remains at the normal mode. The operation mode determining part 123 switches the operating mode of the touch panel 110 to the noise mode at T6 after a duration of the touch input is ended, that is, at the touch input end time T6.

An operation of the operation mode determining part 123 described with reference to FIG. 16 is applied to an operation mode determining part of a touch sensing device described with reference to FIGS. 1 to 12. That is, the operation mode determining part of the touch sensing device described with reference to FIGS. 1 to 12 may determine a change point of an operating mode of a touch panel, based on whether a touch input is generated, whether noise is generated, and whether a touch panel operates abnormally.

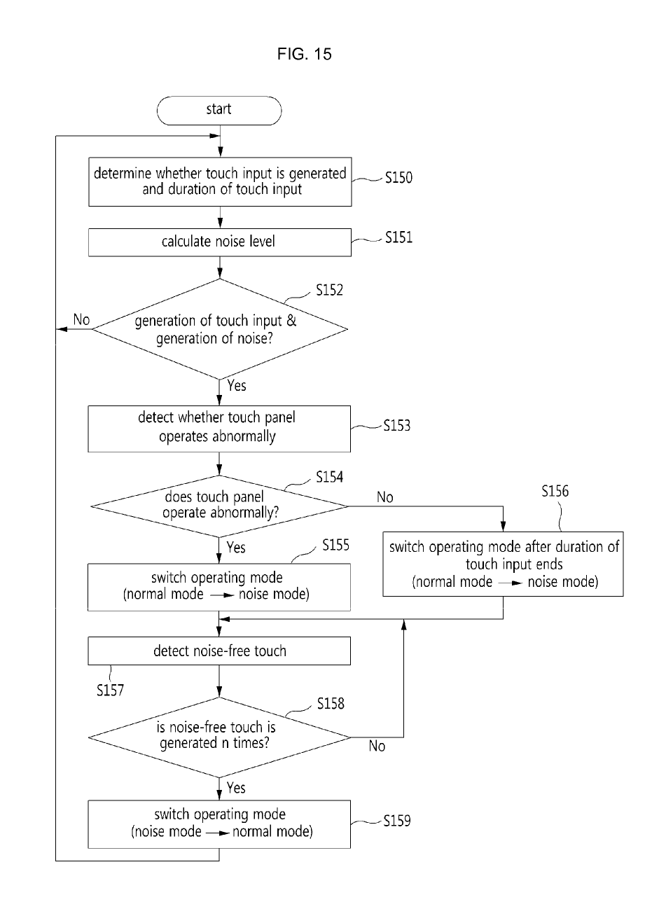

FIG. 15 is a flowchart of a touch sensing method according to another exemplary embodiment of the inventive concept.

First, in step S150, a control unit 120 determines whether a touch input is generated on a touch panel 110 and how long a touch input is held, using a touch determining part 121. In step S151, the control unit 120 determines whether noise is generated on the touch panel 110, using a noise determining part 122.

In step S152, the control unit 122 determines whether a touch input and noise are generated on the touch panel 110, using results of steps S150 and S151. When a touch input or noise is generated on the touch panel 110, the method proceeds to step S159, and an operating mode of the touch panel 110 remains at a normal mode.

When a touch input and noise are generated on the touch panel 110, in step S153, whether the touch panel 110 operates abnormally is determined In step S154, whether the determination indicates that the touch panel 110 operates abnormally is determined. If so, the method proceeds to step S155. If not, the method proceeds to step S156. In step S155, the operating mode of the touch panel 110 is switched from the normal mode to the noise mode. In step S156, the operating mode of the touch panel 110 is switched from the normal mode to the noise mode after a duration of the touch input is ended.

As operations in the noise mode, steps S157 to S159 are substantially the same as steps S33 to S35 of FIG. 3, and a duplicated description thereof is thus omitted.

In the touch sensing device and method according to another exemplary embodiment of the inventive concept, an operation mode determining part may flexibly determine a time point when an operating mode of a touch panel is switched. In the event that the touch panel operates abnormally when a touch input and noise are simultaneously generated, a touch input being currently conducted may be determined as not existing, if the operating mode of the touch panel is switched without condition. In the touch sensing device and method according to another exemplary embodiment of the inventive concept, the operating mode of the touch panel is not switched without condition as soon as noise is generated, but a change point of the operating mode of the touch panel is determined based on whether the touch panel operates abnormally. Accordingly, it is possible to provide touch sensing device and method capable of appropriately switching an operating mode according to a condition where noise is generated.

### MODE FOR INVENTION

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

1. A touch sensing device comprising:
a touch panel configured to receive a touch input; and
a control unit including a touch determining part configured to determine whether a touch input is generated on the touch panel, based on the touch signal; a noise calculation part configured to calculate a level of noise input on the touch panel; and an operation mode determining part configured to select one of a noise mode and a normal mode as an operating mode of the touch panel, based on the calculated noise level.

2. The touch sensing device of claim 1, wherein the noise mode is a mode where at least one of sensitivity of the touch panel, a touch signal sensing speed, and a multi-touch determining ability of the touch panel about the noise mode is reduced as compared with the normal mode.

3. The touch sensing device of claim 1, further comprising:
a driving part configured to apply a driving signal to the touch panel; and
a sensing part configured to receive the touch signal from the touch panel,
wherein the touch panel comprises a plurality of driving electrodes to which a driving signal from the driving part is applied and a plurality of sense electrodes which transfers the touch signal to the sensing part.

4. The touch sensing device of claim 3, wherein when no driving signal is applied to the driving electrodes, the noise calculation part calculates the noise level based on touch signals obtained from the plurality of sense electrodes, and
wherein when the noise level is over a first noise threshold value, the operation mode determining part switches the operating mode of the touch panel from the normal mode to the noise mode.

5. The touch sensing device of claim 4, wherein the noise level corresponds to a sum of values of touch signals detected from the plurality of sense electrodes when no driving signal is applied to the driving electrodes.

6. The touch sensing device of claim 4, wherein when no driving signal is applied to the driving electrodes, the noise level corresponds to a difference between a maximum value and a minimum value of values of touch signals detected from the plurality of sense electrodes.

7. The touch sensing device of claim 3, wherein the noise calculation part calculates the noise level based on the touch signals from the plurality of sense electrodes, and
wherein the operation mode determining part counts the number of events that a noise-free touch is generated on the touch panel and switches the operating mode of the touch panel from the noise mode to the normal mode based on the number of events thus counted.

8. The touch sensing device of claim 7, wherein the noise-free touch indicates the event that a touch input having a noise level smaller than a second noise threshold value is generated during a period longer than a first time period.

9. The touch sensing device of claim 7, wherein the operation mode determining part switches the operating mode of the touch panel from the noise mode to the normal mode when the noise-free touch is continuously generated three times.

10. A touch sensing method comprising:
determining whether a touch input is generated on a touch panel for receiving a touch signal;
calculating a level of noise input on the touch panel; and
selecting one of a noise mode and a normal mode as an operating mode of the touch panel, based on whether the touch input is generated and the calculated noise level.

11. The touch sensing method of claim 10, wherein the noise mode is a mode where at least one of sensitivity of the touch panel, a touch signal sensing speed, and a multi-touch determining ability of the touch panel about the noise mode is reduced as compared with the normal mode.

12. The touch sensing method of claim 10, wherein the determining of whether a touch input is generated comprises determining that a touch input is generated on the touch panel, if a level of the touch signal is over a touch threshold value with a driving signal applied to the touch panel,
wherein the calculating of a level of noise comprises calculating a sum of values of touch signals detected from a plurality of sense electrodes or a difference between a maximum value and a minimum value of the values of the touch signals, when a driving signal is not applied to the driving electrode, and
wherein the selecting of one of a noise mode and a normal mode comprises switching the operating mode of the touch panel from the normal mode to the noise mode when a touch input is generated on the touch panel and the noise level is over a first noise threshold value.

13. The touch sensing method of claim 10, wherein the selecting of one of a noise mode and a normal mode comprises:
counting the number of events that a noise-free touch is generated on the touch panel; and
switching the operating mode of the touch panel from the noise mode to the normal mode based on the number of events thus counted.

14. The touch sensing method of claim 13, wherein the noise-free touch indicates the event that a touch input having a noise level smaller than a second noise threshold value is generated during a period longer than a first time period.

15. A touch sensing device comprising:
a touch panel configured to receive a touch input; and
a control unit including a touch determining part configured to determine whether a touch input is generated on the touch panel and a duration of the touch input; a noise determining part configured to determine whether noise is generated on the touch panel; and an operation mode determining part configured to switch an operating mode of the touch panel from a normal mode to a noise mode, based on whether noise is generated, whether the touch input is generated, and whether the touch panel operates abnormally.

16. The touch sensing device of claim 15, wherein the noise mode is a mode where at least one of sensitivity, a touch signal sensing speed, and a multi-touch determining ability of the touch panel about the noise mode is reduced as compared with the normal mode.

17. The touch sensing device of claim 15, wherein when a touch input and noise are generated on the touch panel but the touch panel is determined as not operating abnormally, the operation mode determining part switches the operating mode of the touch panel from the normal mode to the noise mode after the duration of the touch input is ended.

18-20. (canceled)
